(19) United States
(12) Patent Application Publication
(10) Pub. No.: US 2022/0354100 A1
(43) Pub. Date: Nov. 10, 2022

(54) Hook Caddy

(71) Applicants: Jonathan Morgan, Pompano Beach, FL (US); Brett Siegmeister, Hope, NJ (US); George Barsa, Jackson, NJ (US)

(72) Inventors: Jonathan Morgan, Pompano Beach, FL (US); Brett Siegmeister, Hope, NJ (US); George Barsa, Jackson, NJ (US)

(21) Appl. No.: 17/737,048

(22) Filed: May 5, 2022

Related U.S. Application Data
(60) Provisional application No. 63/184,235, filed on May 5, 2021.

(51) Int. Cl. A01K 87/00

(52) U.S. Cl. CPC A01K 87/009

(57) ABSTRACT

A hook caddy that can be coupled to a fishing rod to provide a safe and convenient place to store fish hooks while fishing, comprising a body with a plurality of holes through it, each hole for securely holding a respective hook inserted therethrough, and a coupling element to couple the body to a fishing rod. In an embodiment, the coupling element includes an opening in the side of the body through which a fishing rod can pass, into a tubular hole having a circular cross section for coupling the body to the fishing rod. In an embodiment, a strip of hook and loop material may be used to more securely couple the hook caddy to the fishing rod.

### CROSS-REFERENCE TO RELATED APPLICATIONS

This application claims priority to U.S. provisional patent application entitled Hook Caddy, filed on May 5, 2021 having Ser. 63/184,235, which is incorporated herein by reference in its entirety.

### FIELD OF THE INVENTION

The invention relates to the field of accessories and products for use in fishing using a fishing rod.

### BACKGROUND

In the prior art, fishing using a rod commonly entails carrying a tackle box that contains, among other things, fishing hooks, lures, and the like. It sometimes happens that a hooked fish will escape from the line, causing the hook to be lost. When this happens, the user must replace the lost hook. To do so, they typically have to go to the tackle box and retrieve a hook every time they need another one. If the box is inconveniently disposed, this may require walking, stooping, kneeling, or the like. If the contents of the box are not well organized, it may also require rooting around in the box for a hook, possibly getting stabbed by the hook. If this procedure could be avoided, the user could not get stabbed rooting through the tackle box, and could spend more time fishing and less time replacing the hook.

### SUMMARY

A hook caddy comprising a body having a plurality of holes extending through the body, each hole for securely holding a respective hook inserted therethrough, and a coupling element to couple the body to a fishing rod. In an embodiment, the coupling element includes an opening in the side of the body through which a fishing rod can pass, and a tubular hole having a circular cross section for coupling the body to the fishing rod. In an embodiment, a ship of hook and loop material is used to secure the coupling.

### BRIEF DESCRIPTION OF THE DRAWINGS

FIG. 1 shows a perspective view of a body of an illustrative embodiment.

FIG. 2 shows a top view of the embodiment of FIG. 1.

FIG. 3 shows a cross sectional view of the embodiment of FIG. 1 at the location shown in FIG. 2.

FIG. 4 is a top view of an exemplary coupling component for use in conjunction with the illustrative embodiment of FIG. 1.

FIG. 5 is a side view of the coupling component of FIG. 4.

### DETAILED DESCRIPTION

Various embodiments and aspects of the invention are described more fully below with reference to the accompanying drawings, which form a part of this specification. However, these and other embodiments may be implemented in many different forms. As such, the described embodiments and aspects should not be construed to limit the scope of the invention. Rather, these embodiments and drawings are provided to illustrate principles of the invention, the scope of which is determined by the claims.

Reference in the specification to “an embodiment” or “embodiments” means that a particular feature, structure, characteristic or other aspect described herein is included in at least one embodiment of the invention. Appearances of the phrase “one embodiment” or “an embodiment” are not necessarily referring to the same embodiment, and may include multiple embodiments.

It is to be understood that the figures and descriptions provided herein may have been simplified to illustrate aspects that are relevant for a clear understanding of the herein described processes, machines, manufactures, and/or compositions of matter, while eliminating, for the purpose of clarity, other aspects that may be found in typical devices, systems, and methods. Those of ordinary skill in the pertinent art may recognize that other elements and/or steps may be desirable and/or necessary to realize the devices, systems, and methods described herein. Because such elements and steps are well known in the art, and because they do not facilitate a better understanding of the present disclosure, a discussion of such elements and steps may not be provided herein. However, the present disclosure is deemed to inherently include all such elements, variations, and modifications to the described aspects that would be known to those of ordinary skill in the pertinent art.

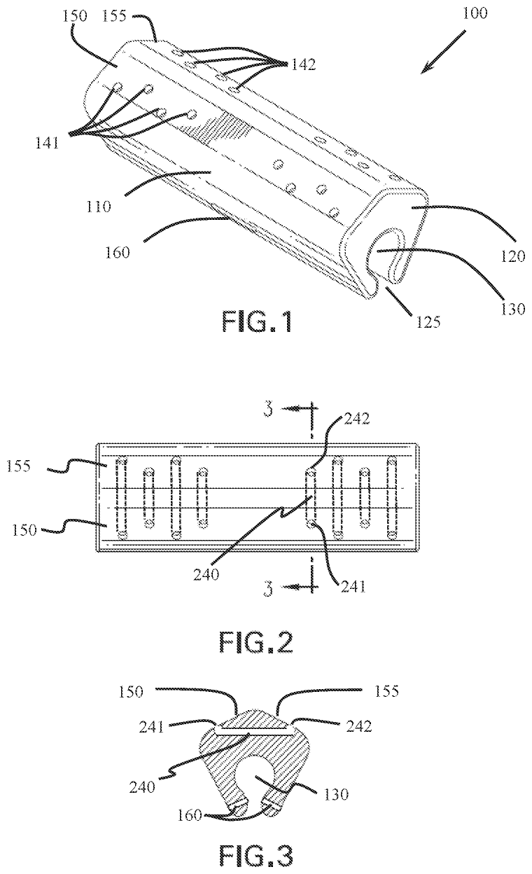

Turning now to the figures, FIG. 1 shows a perspective view of a portion 100 of an exemplary embodiment. The portion comprises a long, narrow body 110 having a cross section generally in the shape of a pentagon 120, coming to a point at the top. As shown, the points of the pentagonal shape are truncated and rounded, although other shapes may be used. An opening 125 along the bottom of the body opens into a generally circular space 130. A plurality of hole openings 141, 142 extend through the two surfaces adjacent to the top of the pentagonal shape 150, 155, respectively. The hole openings are disposed in corresponding pairs, being the openings at both ends of a hole extending through the body at a position above the circular space 130. In embodiments, the body HO may also have a slit 160 passing through each of the bottom two sides at corresponding positions on either side of and proximate to the opening 125.

FIG. 2 is a top view of the body shown in FIG. 1. The holes through the body are indicated in dashed lines. One of the holes, 240, is shown passing straight through the body between hole openings 241, 242. The numerals “3” indicate the position of a plane passing vertically through the body defining a cross sectional area.

FIG. 3 shows the cross-section of the body indicated in FIG. 2 through the plane 3. As shown, the plane 3 cuts through hole 240 passing in a straight line through the top portion of the body above the circular space 130. One end 241 of the bole 240 is disposed on one of the surfaces adjacent to the top of the body. 150, and the other end 242 of the hole 240 is disposed on the other surface adjacent to the top of the body, 155. In embodiments, slit 160 shown in dashed lines may pass through the two lower sides of the body proximate the bottom of the body.

In embodiments, the body shown in FIGS. 1, 2, and 3 may alone constitute a hook caddy. If so, slits 160 may be left out. In an exemplary operation, the body 110 is pressed onto a fishing rod, which passes through the opening along the bottom of body 110, and into the circular space 130. The fishing rod is thereby disposed within the circular space 130, coupling the body 110 to the fishing rod. As such, body 110 must be formed of or comprise a material that is at least slightly or partially bendable, flexible, or otherwise reversibly deformable. That is, the body 110 acts to maintain its shape as it is being deformed by an applied pressure, and returns to its original shape when the pressure is released. As such, when the fishing rod is pressed through the opening 125 at the bottom of body 110, the fishing rod pushes the opening wide enough to pass through it and into the circular space 130. In embodiments, the circular space 130 may have a diameter slightly smaller than that of the portion of the fishing rod to which it is to be coupled, and acts to grip the fishing rod as it tries to return to its original shape. In embodiments, the wall of circular space 130 may be made of or comprise a material that provides an amount of friction with the side of the fishing rod sufficient to prevent the hook caddy from sliding along the fishing rod when they are coupled together. Materials suitable for these purposes include hard rubber, deformable plastic with a rubber layer on the wall of the circular space 130, or the like. Individual fish hooks may then be inserted through respective ones of the holes 240, making the hooks easily and conveniently accessible when needed.

In an exemplary operation, the body 110 is pressed onto a fishing rod, which passes through the opening along the bottom of body 110 and into the circular space 130. The fishing rod is thereby disposed within the generally circular space 130, coupling the body 110 to the fishing rod. As noted previously, body 110 must be formed of or comprise a material that is reversibly deformable and provides a high coefficient of friction when pressed against the side of the fishing rod, such as hard rubber.

In other embodiments the hook caddy may include a coupling component to hold the body 110 firmly in place when it is coupled to the fishing rod. This particularly desired if the body is made of a material that may not provide a high coefficient of friction when pressed against the side of the fishing rod. The coupling component may be or include at least one of a clamp, a screw, a magnet, a nut and bolt, an adhesive, a knot, a snap, a hook and loop fastener, or the like. The body 110 of embodiments that comprise a coupling component may need to be modified to accommodate the coupling component and allow it to function. For example, a strip of hook and loop fastener material may be used as the coupling component, and if so, the body 110 may be modified, as described below.

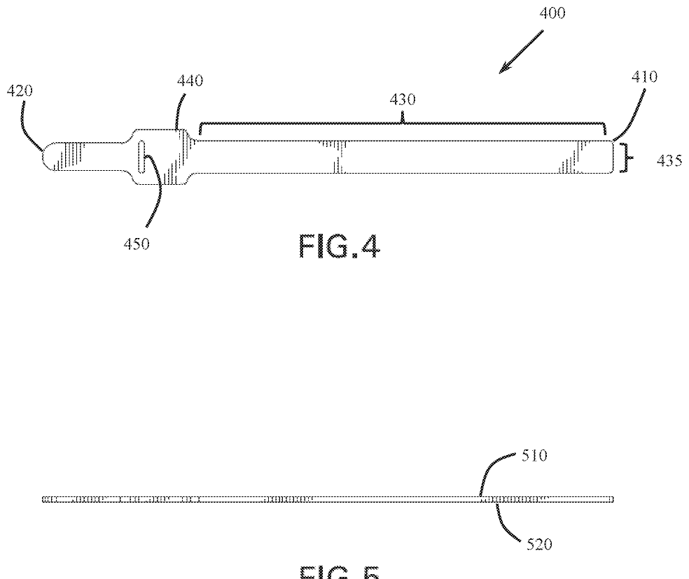

FIG. 4 shows a top view, and FIG. 5 shows a side view, of an exemplary coupling component comprising a strip 400 of hook and loop fastener material, having hooks on one side 510 and loops on the other side 520. The strip may be made of or comprise a strong, flexible, durable material. When the side of the strip having hooks 510 is pressed firmly against the side of the strip with loops 520, the hooks and loops couple strongly together, and can thereafter be pulled apart. As shown, strip 400 has a first end 410 and a second end 420. Most of the length 430 of the strip terminates at end 410, and has a uniform width 435 that is no wider than the slits 160 (shown in FIG. 1) proximate the bottom of the body 110. However, a portion 440 of the strip proximate the second end 420 is wider than width 435. The wider portion 440 has a slit 450 passing through it at least as wide as width 435, through which the end 410 can be inserted.

In an exemplary operation, the body 110 is pressed onto a fishing rod, which passes through the opening along the bottom of body 110 into the circular space 130. The fishing rod is thereby disposed within the generally circular space 130, coupling the body 110 to the fishing rod. When the body 110 is thus coupled to the fishing rod, the end 410 of the hook and loop strip 400 may be inserted through both slits 160 proximate the bottom of body 110. Strip 400 may then be wrapped around the body 110 coupled to the fishing rod. Strip end 410 may then be inserted through slit 450 in the wider portion 440 of the strip, the strip is pulled taught, and the free portion of the strip is pulled to overlap the wrapped portion of the strip. The overlapping portions are then pressed firmly together, thereby coupling the body 110 tightly onto the fishing rod. As before, individual fish hooks may then be inserted through respective ones of the holes 240, making the hooks easily and conveniently accessible when needed.

In embodiments, the hook caddy may further be configured to hold other fishing gear. For example, using the caddy may allow a fisherman quick and easy access to snelled fishing hooks that are already tied to a leader line, ready to be tied to a main line for casting.

Although this invention has been described with a certain degree of particularity, it is to be understood that the present disclosure has been made by way of illustration and not limitation. Changes in the details of construction and arrangement of parts may be made without departing from the spirit and the scope of the invention, provided they comport with the claims.

What is claimed is:

1. An apparatus for coupling fish hooks to a fishing rod, the apparatus comprising a body configured to hold one or more fish hooks and to attach directly to a fishing rod.

2. The apparatus of claim 1, wherein the body is configured to have an opening in a side of the body configured to pass a fishing rod, the opening further configured for the fishing rod to access a circular space in the body, thereby coupling the body to the fishing rod.

3. The apparatus of claim 1, wherein the body is configured to removably hold the fish hooks in a plurality of respective holes passing through the body.

4. The apparatus of claim 1, wherein the body comprises hard rubber.

5. The apparatus of claim 1, wherein the body is configured to removably hold the fish hooks using at least one of a plurality of respective magnets permanently coupled to the body and a plurality of respective slits formed in the body.

6. An apparatus for coupling fish hooks to a fishing rod, the apparatus comprising:
a body configured to hold one or more fish hooks, and;
a coupler configured to couple the body to a fishing rod.

7. The apparatus of claim 6, wherein the coupler comprises at least one of a clamp, a screw, a magnet, a nut and bolt, an adhesive, a knot, a snap, a hook and loop fastener, and a circular space formed in the body configured to hold a fishing rod that has passed through an opening in the side of the body.

8. The apparatus of claim 7, wherein the coupler is attached to the body using at least one of a rivet, a stitch, a screw, a nut and bolt, and an adhesive.

9. The apparatus of claim 6, wherein the body includes an opening in a side of the body configured to pass a fishing rod therethrough, the opening further configured with a circular space in the body accessed through the opening for coupling the body to the fishing rod.

10. The apparatus of claim 6, wherein the body is configured to removably hold the fish hooks in a plurality of respective holes passing through the body.

11. The apparatus of claim 6, wherein the body comprises hard rubber.

12. The apparatus of claim 6, wherein the body is configured to removably hold the fish hooks using at least one of a plurality of respective magnets permanently coupled to the body and a plurality of respective slits formed in the body.

13. The apparatus of claim 7, wherein the hook and loop fastener is used to couple the body to the fishing rod, the hook and loop faster comprising:
a flexible strip of durable material having a first end and a second end;
the flexible strip also having a first side and a second side;
the flexible strip also having a plurality of hooks on one of the sides and a plurality of loops on the other of the sides;
the body configured to surround a portion of a fishing rod; and
one of the flexible strip ends configured to pass through at least one slit formed in the body, the strip configured to wrap around the body when the portion of the fishing rod is surrounded by the body, the strip configured such that a portion of the hooks on one side of the strip couples firmly to a portion of the loops on the other side of the strip to secure the body firmly to the fishing rod.

14. A method of carrying fish hooks when fishing, comprising:
coupling a body of a hook caddy to a fishing rod; and
inserting a fish hook into respective ones of a plurality of holes in the body.

15. The method of claim 14, further comprising, after the coupling step, securing the hook caddy to the fishing rod with a coupling device.

16. The method of claim 14, wherein the coupler comprises at least one of a clamp, a screw, a magnet, a nut and bolt, an adhesive, a knot, a snap, a hook and loop fastener, and a circular space formed in the body configured to hold a fishing rod that has passed through an opening in the side of the body.

17. The method of claim 16, wherein the coupler is attached to the body using at least one of a rivet, a stitch, a screw, a nut and bolt, and an adhesive.

18. The method of claim 14, wherein the body includes an opening in its side, configured to pass a fishing rod therethrough, the opening further configured with a circular space in the body accessed through the opening for coupling the body to the fishing rod.

19. The method of claim 14, wherein the body comprises hard rubber.

20. The method of claim 19, wherein the coupling of the body to the fishing rod is effected by:
reversible deformation of the body occurring as the body is pushed onto and pulled off of the fishing rod through an opening in the side of the body; and
a high coefficient of friction between the surface of the circular space within the body and the fishing rod while the fishing rod is disposed within the circular space that receives the fishing rod after the body is pushed through the opening.
